(19) United States
(12) Patent Application Publication
(10) Pub. No.: US 2017/0050826 A1
(43) Pub. Date: Feb. 23, 2017

(54) POWERED HAND CHAIN DRIVE

(71) Applicant: STEWART ENGINEERING & SALES CO., MUSKEGON, MI (US)

(72) Inventor: Kenneth J. Stewart, Muskegon, MI (US)

(21) Appl. No.: 15/236,954

(22) Filed: Aug. 15, 2016

Related U.S. Application Data
(60) Provisional application No. 62/206,526, filed on Aug. 18, 2015.

(51) Int. Cl. B66D 1/12

(52) U.S. Cl. CPC B66D 1/12; B66D 2700/025

(57) ABSTRACT

A chain hoist drive for operating a hand chain of a hand chain hoist. A housing forms a void through which a hand chain of the hand chain hoist moves in either a lifting direction or a lowering direction, to lift or lower, respectively, a load corresponding to the hand chain hoist. A sprocket is movably mounted within the housing. A drive, such as a right angle drill, operably moves the sprocket and thus moves the hand chain, selectively, in the lifting direction or the lowering direction. A line, a cord and/or another suitable structural element connects the housing to an overhead structure. Another line, cord and/or other suitable structural element connects or holds the housing with respect to a ground surface or another fixed structural element, and an operator can use this line, which can be adjustable, to tighten and hold the overall chain hoist drive time of this invention.

### CROSS REFERENCE TO RELATED APPLICATION

This Patent Application claims the benefit of U.S. Provisional Patent Application having Ser. No. 62/206,526, filed on 18 Aug. 2015, and this co-pending U.S. Provisional Patent Application is incorporated by reference herein in its entirety and is made a part of this specification and of this Patent Application, including but not limited to those portions which specifically appear in this Patent Application.

### BACKGROUND OF THE INVENTION

Field of the Invention

This invention relates to a hand hoist drive to operate a hand chain hoist that is powered with a right angle drive and used by an operator to eliminate the labor required to pull on the hand chain.

Discussion of Related Art

Hand chain drives are used primarily to operate hand chain hoists, and also large overhead doors and valves.

Conventional hand chain hoists have been used for many years to lift workpieces and other loads. Some powered portable devices are known to operate manual chain hoists. For example, U.S. Pat. Nos. 5,678,452, 6,179,270 and 6,820,863 disclose portable powered drivers for operating chain hoists, and the entire disclosures of each and every one of U.S. Pat. Nos. 5,678,452, 6,179,270 and 6,820,863 are incorporated into this specification by reference thereto.

Conventional drills and other drives or drivers have been used to supply a rotating shaft to a workpiece. For example, conventional drills have a rotating head or chuck piece that can be attached to a drill bit or a grinder wheel to rotate a workpiece.

There is an apparent need for a device that can be easily attached to an existing hand chain of a hand chain hoist, to power operate the hand chain in a lifting direction or a lowering direction.

### SUMMARY OF THE INVENTION

A hand chain drive according to this invention can power operate any standard hand chain operated device such as a hoist, a door or a valve. The chain drive of this invention accepts a lifting section of a hand chain from a hand chain hoist, for lifting a load, is operated to lift the load, and then returns the lifting section of the chain to the conventional hand chain hoist which is located overhead or above the chain hoist drive of this invention. The chain drive of this invention is moved to the lowering section of the chain from the hand chain hoist, for lowering the load, and then returning the lowering section of the chain to the conventional hand chain hoist.

According to some embodiments of this invention, an upper section of a line is attached to an overhead structure, such as a hoist or a trolley, and an opposite lower section of the line is attached to a support frame or structure to which a right angle drive can be mounted. Using the line and support frame balances and eliminates the weight and resulting torsional loads that an operator experiences while operating the chain hoist drive of this invention. For example, the operator can use one hand to hold onto and guide the support frame and use the other hand to operate the drive.

In some embodiments of this invention, the operator can lift a load in a first direction and then move the hand chain of this invention to lower the load in a second direction which is opposite or different with respect to the first direction. In some embodiments of this invention, the drive sprocket or pulleys can be universally designed to accommodate different hand chain sizes as supplied by various hoist manufacturers.

### BRIEF DESCRIPTION OF THE DRAWINGS

The features of different embodiments of this invention can be better understood when described in view of the drawings, wherein:

FIG. 1 shows a front view of a chain hoist drive with a hand chain, according to one embodiment of this invention;

FIG. 2 shows a side view of the chain hoist drive, as shown in FIG. 1 but without a hand chain;

FIG. 3 shows a front view of a drive, such as a right angle drill and/or a right angle drive, according to one embodiment of this invention;

FIG. 4 shows a side view of the drive, as shown in FIG. 3;

FIG. 5 shows a side view of a support frame, according to one embodiment of this invention;

FIG. 6 shows a front view of the support frame, as shown in FIG. 5;

FIG. 7 shows a broken top view of the support frame, as shown in FIGS. 5 and 6;

FIG. 8 shows a side view of a sprocket, according to one embodiment of this invention;

FIG. 9 shows a front view of the sprocket, as shown in FIG. 8;

FIG. 10 shows a top view of the sprocket, as shown in FIG. 8;

FIG. 11 shows a view of the sprocket, taken along line 11-11 as shown in FIG. 9;

FIG. 12 shows a front view of a chain, such as a hand chain, according to one embodiment of this invention;

FIG. 13 shows a front view of a housing, according to one embodiment of this invention;

FIG. 14 shows a sectional view of the housing, taken along line 14-14 as shown FIG. 13;

FIG. 15 shows a rear view of the housing, as shown in FIG. 13;

FIG. 16 shows a top view of the housing, as shown in FIG. 13;

FIG. 17 shows a partial front view of a fastener, according to one embodiment of this invention;

FIG. 18 shows a front view of an element for the housing, according to one embodiment of this invention;

FIG. 19 shows a partial side view of a handle and an anchor, according to one embodiment of this invention;

FIG. 20 shows a partial front view of the handle and the anchor, as shown in FIG. 19;

FIG. 21 shows a front view of an anchor, according to one embodiment of this invention;

FIG. 22 shows a side view of the anchor, as shown in FIG. 21;

FIG. 23 shows a side view, opposite the side view shown in FIG. 22, of the anchor, as shown in FIG. 21; and

FIG. 24 shows a front view of a chain hoist drive with a hand chain, according to one embodiment of this invention.

### DETAILED DESCRIPTION OF THE INVENTION

FIG. 1 shows a front view of chain hoist drive 10, with chain 15, according to one embodiment of this invention. For clarity purposes, FIG. 2 shows a side view of chain hoist drive 10 as shown in FIG. 1, but without chain 15. When used to lift a load, chain 15 enters, passes through and exits housing 20, such as shown in FIG. 1. In some embodiments of this invention, housing 20 comprises design features and/or elements that allow housing 20 to guard, guide, strip and return chain 15, such as shown in FIG. 1, as chain 15 enters, passes through and/or exits housing 20. In some embodiments of this invention, the guard prevents pinching of fingers, hands and the like, for example, between a moving hand chain 15 and sprocket 50. In some embodiments of this invention, the guide orientates the links of chain 15, for example, for proper entry into sprocket 50. The stripper feature helps or ensures that chain 15 exits or releases from sprocket 50. In some embodiments of this invention, the return reverses a direction of chain 15 moving toward a ground surface or a floor.

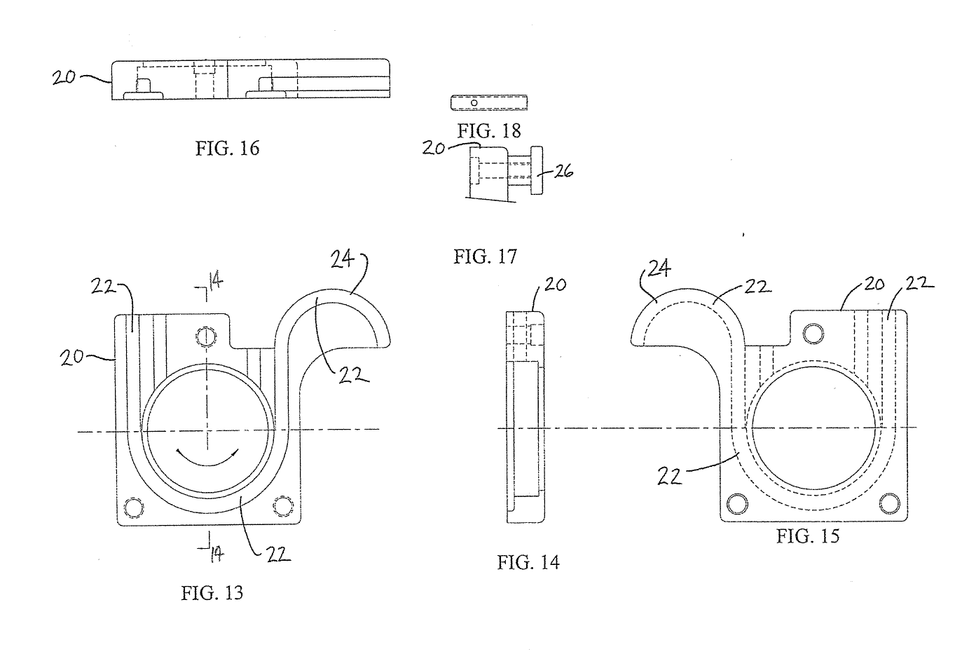

According to some embodiments of this invention, chain hoist drive 10 can be used to operate a hand chain, such as chain 15, of a hand chain hoist, such as a conventional hand chain hoist. In some embodiments of this invention, such as shown in FIGS. 13-16, housing 20 forms or has void 22 forming a pathway or a channel through which chain 15 can pass. Chain 15 can be movably mounted within void 22. In some embodiments of this invention, sprocket 50 is movably mounted within housing 20. For example, sprocket 50 can be mounted to move, rotate, pivot and/or otherwise move in any suitable fashion to engage with and accommodate chain 15, for example, so that chain 15 is movable within or through void 22 and engageable with sprocket 50.

FIGS. 1 and 2 show an upper portion of line 17 that is routed to and detachably connected or otherwise attached to an overhead structure and/or an overhead unit, such as a hoist or a trolley. In some embodiments of this invention, the opposite or lower end portion of line 17 is secured, connected and/or otherwise attached to a structure that connects directly or indirectly to or with support frame 30. As shown in FIGS. 1 and 2, line 17 is secured, connected and/or otherwise attached to hook 18 which can be detachably secured to support eye 32 of support frame 30. In other embodiments of this invention, hook 18 can comprise a snap or other safety feature and/or any other suitable fastener or connector that detachably connects support frame 30 with respect to line 17. As shown in FIGS. 1 and 2, line 17 comprises a cable but line 17 can comprise a chain and/or any other suitable structural element that connects support frame 30 with respect to the overhead structure or the overhead unit, such as the hoist or the trolley.

In some embodiments of this invention, line 17 comprises a structural element connecting housing 20 with respect to the overhead structure and/or any other suitable structure. The first structural element can be detachably connected to housing 20. In some embodiments of this invention, the first structural element is or comprises line 17 which is connected to the overhead structure and/or any other suitable structure.

FIGS. 1 and 2 show support frame 30 comprising support eye 32 that can be detachably connected and/or secured to line 17 and/or hook 18 or another suitable attachment device. Although it is possible to use the hand chain drive 10 without a secured or locked attachment between hook 18 and support eye 32, using the secured or locked attachment, such as with hook 18 having a spring-loaded snap feature or another suitable locking device, provides additional safety while operating chain hoist drive 10 according to this invention.

In some embodiments of this invention, the attachment device detachably connects line 17 or the corresponding structural element with respect to housing 20. FIG. 1 shows hook 18 having a locking device, for example, a spring-loaded device that can be used to releasably hold or lock line 17 or the corresponding structural element with respect to housing 20 and/or any other elements connected directly to or indirectly with respect to housing 20, such as support eye 32 shown in FIGS. 1, 2 and 5-7.

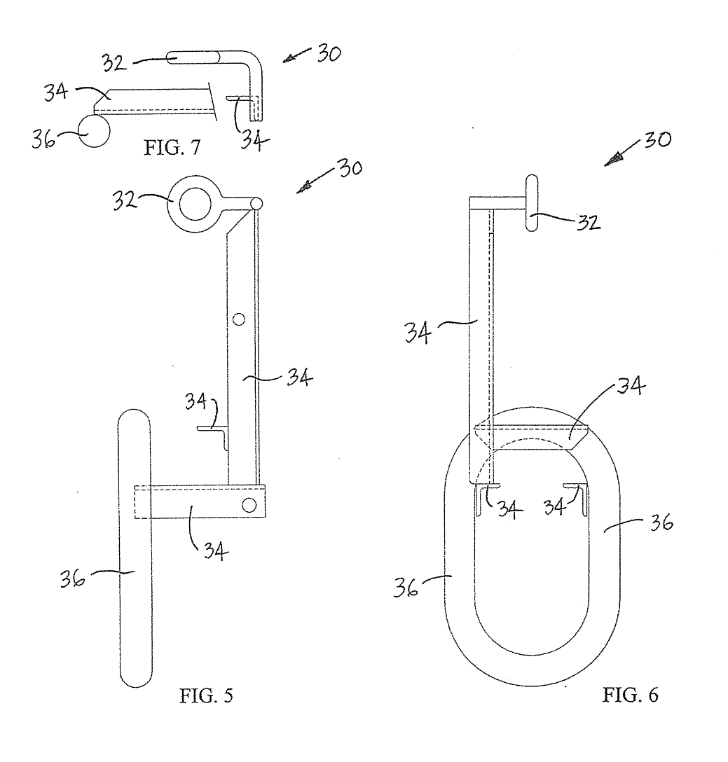

FIGS. 5-7 show different views of support frame 30 according to one embodiment of this invention, comprising support eye 32 welded or otherwise secured to one or more structural elements 34. FIGS. 5-7 also show structural ring 36 welded or otherwise secured to one or more structural elements 34. In other embodiments according to this invention, support frame 30 can be one integrated element and/or can have any other suitable structural shape and design that accommodates housing 20 and drive 40, such as a right angle drive which may or may not be a right angle drill. In some embodiments according to this invention, support frame 30 allows an operator to experience a lightened load during operation, for example, by the operator holding structural ring 36 and thus reducing or lessening the forces and/or loads the operator experiences, particularly when lifting a load at or near a maximum amount or weight.

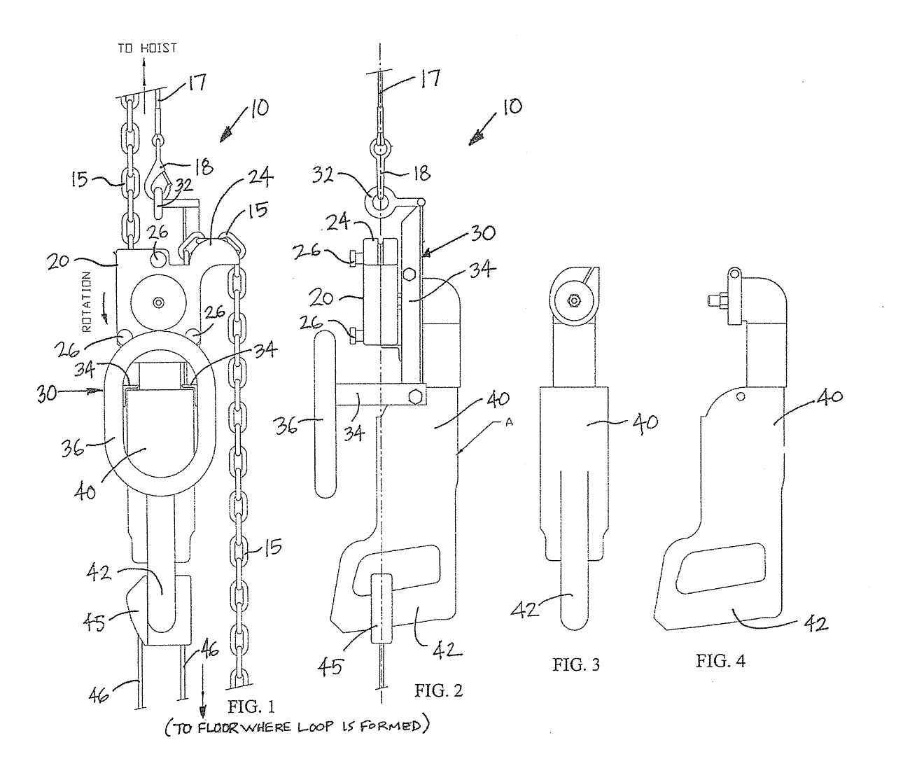

FIGS. 3 and 4 show one embodiment of drive 40, which can be a conventional drill and/or drive. According to some embodiments of this invention, drive 40 can be any suitable conventional drill and/or drive, including but not limited to a right angle drill and/or drive. In some embodiments of this invention, drive 40 is operably connected to sprocket 50, for example, so that operating drive 40 rotates and/or otherwise moves sprocket 50. Operating or otherwise engaging or employing drive 40 can result in moving sprocket 50 which engages with and thus moves chain 15. In some embodiments of this invention, drive 40 moves sprocket 50 with respect to housing 20.

One embodiment of this invention, such as shown in FIGS. 3 and 4, includes drive 40 without a drill chuck or with the drill chuck removed. In some embodiments of this invention, drive 40 is a right angle drive or drill that engages with and moves sprocket 50 with respect to housing 20 and thus moves chain 15 with respect to sprocket 50 and/or housing 20. As shown in FIGS. 1-4, drive 40 has handle 42 which can be used by an operator to better hold chain hoist drive 10 according to this invention. Any other suitable conventional drill and/or drive can be used in place of drill 40 shown in FIGS. 1-4, but this may require modification to housing 20 and/or support frame 30, for example.

As shown in FIGS. 1, 2 and 24, lower anchor 45 is detachably secured with respect to line 46. In some embodiments of this invention, line 46 is a structural element holding housing 20 with respect to a fixed structural element, such as a structural support, a ground surface and/or any other suitable element that can fix and/or hold line 46 or another suitable structural element. In some embodiments of this invention, a length of line 46 can be varied and/or is adjustable, so that an operator can change a length of line 46 to snug up or tighten the linkage of line 16, housing 20 and line 17, for example, as chain 15 is routed through housing 20.

As shown in FIGS. 1 and 19-24, for example, anchor 45 can be operated and/or engaged to detachably secure housing 20 with respect to line 46 or the corresponding structural element. In some embodiments of this invention, anchor 45 adjustably secures line 46 or the corresponding structural element, for example, so that an operator can adjust the length of line 46 and lock or otherwise secure line 46 with enough force that the operator can use the operator's foot or another suitable fixed structure to hold line 46. In some embodiments of this invention, line 46 or the corresponding structural element releasably holds housing 20 with respect to a fixed structural element or the ground surface.

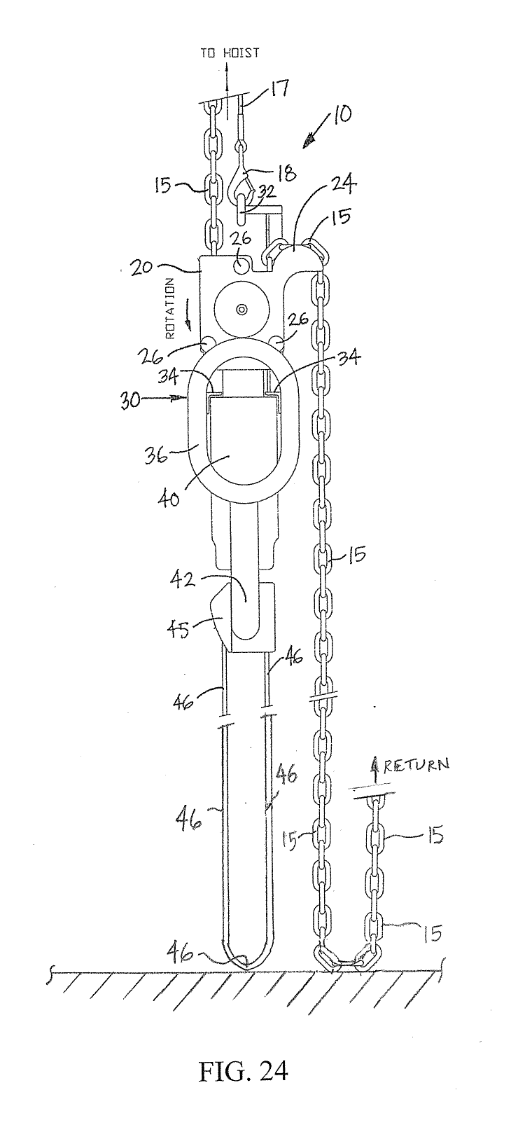

In some embodiments of this invention, line 46 can be adjusted in length, for example, by operating an adjustable securing device to change the length of line 46. In some embodiments of this invention, the operator forms a loop, for example, as shown in FIG. 24, with line 46 and then places the operator's foot on the loop portion of line 46 to hold and/or secure the loop formed by line 46. In other embodiments of this invention, line 46 can be secured and/or otherwise attached to a fixed structural element, such as to a fixed frame or to the ground, a ground surface and/or any suitable fixed structure, so that the operator does not have to use the operator's foot to secure chain hoist drive 10 during operation. However, using the operator's foot provides a faster and more convenient operation of chain hoist drive 10 according to this invention.

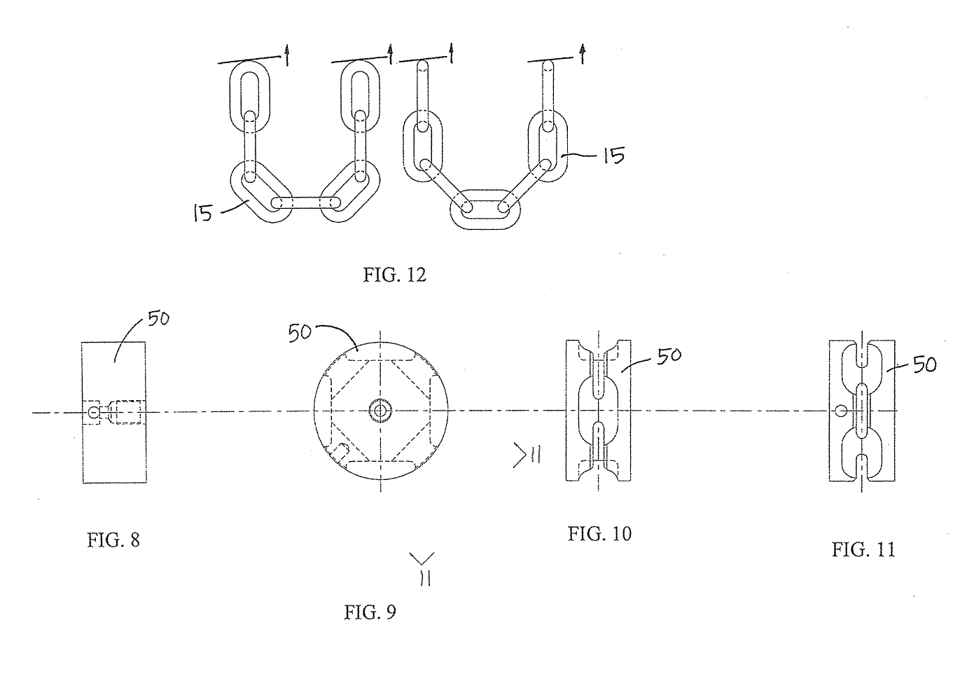

FIGS. 8-11 show different views of sprocket 50, according to one embodiment of this invention. The outer edges of sprocket 50 form the locating and bearing surface for a rotating sprocket 50. As shown in this embodiment of FIGS. 8-11, the features of sprocket 50 can be used with one particular type of chain. However, in other embodiments of this invention, sprocket 50 can have different shapes, design features and/or specifications, so that the same sprocket 50 can accommodate two or more types of chains 15, thus making sprocket 50 somewhat more universal between different manufacturers or providers of chains 15, and thus more capable of handling multiple types of chains 15, such as from different manufacturers, without changing to a different or another sprocket 50.

FIG. 12 shows chain 15 according to one embodiment of this invention. In other embodiments of this invention, chain 15 can have any other suitable features, shapes, dimensions and/or designs.

FIGS. 13-18 show different views of housing 20 comprising different elements and features that allow chain 15 to enter, pass through and exit housing 20 while still allowing chain 15 to be guarded, guided, stripped and returned as chain 15 moves with respect to housing 20. In some embodiments of this invention, housing 20 has one or more voids 22 that allow chain 15 to move with respect to housing 20. In some embodiments according to this invention, housing 20 has return section 24 that can guide chain 15 as it moves with respect to housing 20. Return section 24 can also be used to allow a long enough section of chain 15 to run or be suspended from housing 20 to above the ground or other floor surface, which can keep tension and/or another suitable force on chain 15 so that chain 15 can be exited or discharged from housing 20 without chain 15 binding or stopping with respect to housing 20. In some embodiments of this invention, fasteners 26 can be used to detachably secure a suitable cover with respect to housing 20, so that, for example, a different sprocket 50 can be installed or inserted within a corresponding space or void formed by housing 20.

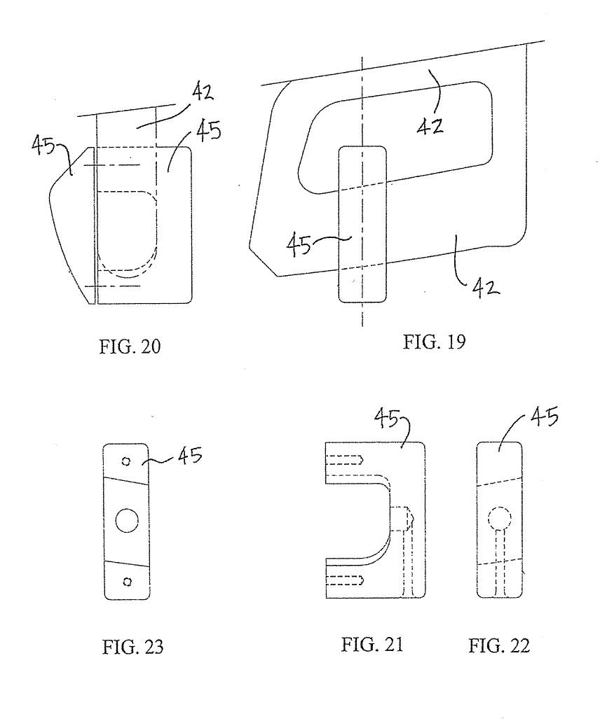

FIGS. 19-23 show different views of lower anchor 45, according to different embodiments of this invention. FIGS. 19 and 20 show one embodiment of lower anchor 45 mounted with respect to handle 42 of right angle drive 40. Lower anchor 45 and drive 40 can have any other suitable shapes and/or dimensions and still allow lower anchor 45 to be detachably secured with respect to drive 40. FIGS. 21-23 show one embodiment of design features of lower anchor 45.

In some embodiments according to this invention, the method of using hand chain drive 10 includes installing and/or securing line 17 to an overhead structure, such as a hoist or a trolley, and attaching hook 18 of line 17 with respect to support frame 30, such as by using support eye 32, resulting in supporting hand chain drive 10 at a level that an operator can use or operate chain hoist drive 10. A cover can be removed from housing 20 and a suitable sprocket 50 can be installed within a space or void formed by housing 20. The cover can be attached to cover and/or retain sprocket 50 within housing 20. When lifting a load with chain hoist drive 10 of this invention, the operator can place the operator's foot on and hold line 46 and then lift the work load by operating drive 40. To then lower the work load, the operator can open the cover, remove the lifting section of the chain and replace it with the lowering section of the chain, replace the cover, and again operate drive 40 to move the load in the opposite direction.

According to some embodiments of this invention, a method for operating chain hoist drive 10, for example, to move chain 15 of a hand chain hoist, includes securing line 17 or the corresponding structural element to the overhead structure. Line 17 or the corresponding structural element is detachably connected to housing 20. Drive 40 can be operated to move chain 15 through housing 20, either in a lifting direction or a lowering direction. Line 46 can be adjusted in length, for example, to hold or secure housing 20 with respect to the fixed structural element or the ground surface.

In some embodiments of this invention, anchor 45 adjustably secures line 46 or the corresponding structural element with respect to housing 20. Line 46 or the corresponding structural element can be used to releasably hold housing 20 with respect to the fixed structural element or the ground surface. In some embodiments of this invention, moving chain 15 through housing 20 includes or comprises moving through housing 20 either a lifting section of chain 15 or a lowering section of chain 15. In some embodiments of this invention, the lifting section and the lowering section are interchangeable with each other, so that an operator can use chain hoist drive 10 of this invention with the lifting section of chain 15 to lift a load by operating a hand chain hoist and then switch out or change the lifting section to the lowering section of chain 15 to lower the load by operating the hand chain hoist.

While in the foregoing specification this invention has been described in relation to certain preferred embodiments, and many details are set forth for purposes of illustration, it will be apparent to those skilled in the art that this invention is susceptible to additional embodiments and that certain of the details described in this specification and in the claims can be varied considerably without departing from the basic principles of this invention.

What is claimed is:

1. A chain hoist drive for operating a hand chain of a hand chain hoist, the chain hoist drive comprising:
a housing having a housing void, the hand chain movably mounted within the housing void, a sprocket movably mounted within the housing, the hand chain movable within the housing void and engageable with the sprocket, a drive operably connected to the sprocket, a first structural element connecting the housing to an overhead structure, and a second structural element holding the housing with respect to a fixed structural element.

2. The chain hoist drive according to claim 1 wherein the drive moves the sprocket with respect to the housing.

3. The chain hoist drive according to claim 1 wherein the drive is a right angle drill engaging and moving the sprocket with respect to the housing.

4. The chain hoist drive according to claim 1 wherein the first structural element detachably connects to the housing.

5. The chain hoist drive according to claim 1 wherein the first structural element is a line connected to the overhead structure.

6. The chain hoist drive according to claim 5 wherein the line is a cable and/or a chain.

7. The chain hoist drive according to claim 1 further comprising an attachment device detachably connecting the first structural element with respect to the housing.

8. The chain hoist drive according to claim 7 wherein the attachment device is a hook having a locking device.

9. The chain hoist drive according to claim 1 wherein a length of the second structural element is adjustable.

10. The chain hoist drive according to claim 1 wherein the second structural element has an adjustable securing device that changes a length of the second structural element.

11. The chain hoist drive according to claim 1 further comprising an anchor detachably securing the housing with respect to the second structural element.

12. The chain hoist drive according to claim 11 wherein the anchor adjustably secures the second structural element with respect to the housing.

13. The chain hoist drive according to claim 1 wherein the second structural element releasably holds the housing with respect to the fixed structural element or a ground surface.

14. A chain hoist drive for operating a hand chain of a hand chain hoist, the chain hoist drive comprising:
a housing having a housing void, the hand chain movable within the housing void, a sprocket moving within the housing, the sprocket engaging the hand chain in the housing void, a drive operating the sprocket, a first structural element connecting the housing to an overhead structure, and a second structural element holding the housing with respect to a fixed structural element or a ground surface.

15. The chain hoist drive according to claim 14 further comprising an anchor detachably securing the second structural element with respect to the housing.

16. The chain hoist drive according to claim 15 wherein the anchor varies a length of and adjustably secures the second structural element with respect to the housing.

17. A method for operating a chain hoist drive to move a hand chain of a hand chain hoist, the method including the steps of:
securing a first structural element to an overhead structure;
detachably connecting the first structural element to a housing;
operating a drive to move the hand chain through the housing; and
holding a second structural element to secure the housing with respect to a fixed structural element or a ground surface.

18. The method according to claim 17 wherein an anchor adjustably secures the second structural element with respect to the housing.

19. The method according to claim 17 wherein the second structural element releasably holds the housing with respect to the fixed structural element or the ground surface.

20. The method according to claim 17 wherein moving the hand chain through the housing includes moving through the housing a lifting section of the hand chain or a lowering section of the hand chain, and the lifting section and the lowering section are interchangeable with each other.
